(19) United States
(12) Patent Application Publication
(10) Pub. No.: US 2025/0384260 A1
(43) Pub. Date: Dec. 18, 2025

(54) Photonic Neural Network

(71) Applicant: Mitsubishi Electric Research Laboratories, Inc., Cambridge, MA (US)

(72) Inventors: Toshiaki Koike-Akino, Framingham, MA (US); Keisuke Kojima, Weston, MA (US)

(73) Assignee: Mitsubishi Electric Research Laboratories, Inc., Cambridge, MA (US)

(21) Appl. No.: 18/966,193

(22) Filed: Dec. 3, 2024

Related U.S. Application Data
(60) Provisional application No. 63/660,122, filed on Jun. 14, 2024.

(51) Int. Cl. G06N 3/067

(52) U.S. Cl. CPC G06N 3/067

(57) ABSTRACT

A computer-implemented artificial intelligence (AI) method is provided for a programmable photonic computer. The AI method includes processing input data, weight parameters, and conditional variables, and embedding the input data, weight parameters, and conditional variables into the programmable photonic computer by controlling a set of adjustable parameters. Light is injected into a set of input ports of the programmable photonic computer, where it is transformed through a series of interferometers and waveguides configured by the adjustable parameters. The transformed light is then detected at the output ports of the programmable photonic computer, and the detected light is output as an inference prediction for an AI task. This process represents a neural network transformation of the input data adjusted by the weight parameters.

### TECHNICAL FIELD

This disclosure relates to a system and a computer-implemented artificial intelligence (AI) method for a programmable photonic computer.

### BACKGROUND

Programmable photonic computers (PPCs) have shown immense potential for accelerating neural networks, delivering speeds exceeding gigahertz per second alongside exceptional energy efficiency. Various types of optical neural network (ONN) implementations exist, which can be broadly categorized into quantum and non-quantum approaches.

A key practical challenge for quantum optical neural networks (QONNs) is the reliance on cryogenically controlled photon counters, which limits their scalability and practicality. In contrast, non-quantum ONNs do not require cryogenics; however, they typically depend on nonlinear photonic devices to achieve universal functionality. Linear photonic neural networks, although a potential alternative, are constrained by their inherently unitary nature. Without control over nonlinear attenuation, their inference performance is often substantially restricted.

For QONNs, qubits are represented by photons. Nonlinear attenuation reduces photon intensity, leading to information loss. This attenuation complicates the accurate transmission of signals, increasing the likelihood of computational errors. Such errors are particularly problematic in quantum systems, where accumulated inaccuracies can severely degrade the overall performance of neural network computations.

Thus, there is a pressing need to develop universal optical neural networks that leverage linear photonic circuits, eliminating reliance on nonlinear attenuation controls and quantum effects while maintaining high performance and scalability.

### SUMMARY

It is an object of some embodiments to provide an artificial intelligence (AI) system and a computer-implemented AI method for a programmable photonic computer.

Each optical component in a programable photonic computer serves a role similar to those in traditional photonic circuits, however, with the added complexity of applying input data multiple times in a series manner. The optical waveguides transmit light, the phase shifter manipulate the phase of the light propagating in different paths, and the directional coupler use photon interference to perform matrix calculations. The photodetectors ultimately measure the processed optical information, providing an interface with external systems through a post processor. Silicon photonics can be used to integrate nanoscale optical waveguides, phase shifters directional couplers and, light sources, and photodetectors.

For instance, the components of a photonic processor need be specially tailored to handle light states while processing signals. The photonic processor is typically built as a photonic integrated circuit (PIC), and the key components include optical waveguides and adjustable interferometers comprising of phase shifters and directional couplers. In this case, the optical waveguides are designed with low loss and minimal phase noise, as they carry photons that act as quantum bits (qubits). The light sources are typically low noise laser sources emitting signals with fixed states. The adjustable interferometers are designed to maintain high coherence while encoding information. Further, the photodetectors are designed to be highly sensitive to read quantum information with minimal noise, and the interferometers are designed to utilize photon interference to perform computations equivalent to neurons in the network.

In the programable photonic computer, signal input and output work similarly to traditional neural networks, with input and output layers. However, the signals are quantum in nature, represented by photons that are transmitted through optical waveguides or fiber optics. Information is processed through changes in the phase and amplitude of these photons, which are eventually measured by photodetectors to output signal information.

According to some embodiments of the present disclosure, data reuploading is evaluated in the context of non-quantum photonic neural networks from various aspects. The disclosed method does not require nonlinear photonic devices, photon counters, or squeezed light sources. Some embodiments of the present disclosure describe advantages in different PIC configurations, binary/non-binary classification strategies, and resilience to fabrication imperfections.

In the present disclosure, some embodiments introduce data reuploading to realize universal non-quantum photonic computing with practical photonic integrated circuits (PICs). Furthermore, some embodiments can eliminate the need of quantum-squeezed lights, photon counters, and nonlinear photonics, which have been essential for enabling photonic neural networks in conventional configurations. Additionally, some embodiments can minimize the optical components by combining multiple functionalities into a single phase shifter, showing competitive performance when compared to using the same number of phase shifters, all without employing any nonlinear photonic devices. Considering these characteristics, the present disclosure realizes the use of PICs for data reuploading presents a novel architectural approach to realize photonic neural networks. This approach embodies unique features that distinctly set it apart from traditional photonic neural networks.

According to some embodiments of the present disclosure, an artificial intelligence (AI) system on a programmable photonic computer is provided. The AI system may include a pre-processor to process input data and weight parameters, a controller to control a set of adjustable parameters to embed the input data and weight parameters into the programmable photonic computer, a light source to inject lights into a set of input ports of the programmable photonic computer, a series of interferometers and waveguides, configured by the set of adjustable parameters to transform the injected lights; a photodetector to detect lights at a set of output ports of the programmable photonic computer, and a post-processor to output the detected lights as an inference prediction for AI task as a neural network transformation of the input data adjusted by the weight parameters.

### BRIEF DESCRIPTION OF THE DRAWINGS

The accompanying drawings, which are included to provide a further understanding of the disclosure, illustrate embodiments of the disclosure and together with the description explain the principle of the disclosure. The drawings shown are not necessarily to scale, with emphasis instead generally being placed upon illustrating the principles of the presently disclosed embodiments.

FIG. 1 shows a schematic of a photonic neural network realized through data reuploading in photonic integrated circuits, according to some embodiments of the present disclosure.

FIG. 2A shows a schematic of an AI system according to embodiments of the present disclosure, where the input data x is supplied, and the weight parameters are provided to the PIC. These inputs are processed within the PIC to generate the output data.

FIG. 2B shows a schematic of a PIC according to embodiments of the present disclosure, wherein the differential phase shifters, waveguides, and directional couplers are arranged to perform photonic processing.

FIG. 2C shows a schematic of a programmable photonic computer according to embodiments of the present disclosure, wherein the input light from the light source is processed at each layer and the output is detected by a photodetector.

FIG. 3A shows a rotation along the z axis, and its corresponding photonic component.

FIG. 3B shows a rotation along the y axis, and its corresponding photonic component.

FIG. 3C shows an example of three-dimensional input data processed through a three-layer network, according to embodiments of the present disclosure.

FIG. 4 shows a schematic of a close translation to a PIC representing a rotation (Rot), according to embodiments of the present disclosure.

FIG. 5 shows the accuracy of the photonic data reuploading method as a function of the number of layers, demonstrated for the three-dimensional sphere and six-dimensional hyper-sphere problems, according to embodiments of the present disclosure.

FIG. 6 shows an example of a four-lane PIC, wherein different light patterns are used as class labels.

FIG. 7 shows the accuracy of the stacking and the implicit classification methods as a function of the number of layers for the two-dimensional four-class wavy line problem, according to embodiments of the present disclosure.

FIG. 8 shows the accuracy of the stacking and the implicit classification methods as a function of the number of Rot blocks for the two-dimensional four-class wavy line problem, according to embodiments of the present disclosure.

FIG. 9 shows a plot of the training data for the two-dimensional four-class wavy line problem. Each color represents different classes, according to embodiments of the present disclosure.

FIG. 10 shows a plot of the test data for the two-dimensional four-class wavy line problem when the accuracy of 98.05% was achieved.

FIG. 11 shows an exemplary embodiment of a four-mode PIC, wherein phase shifters, waveguides, and 50:50 directional couplers create a circuit.

FIG. 12 shows a schematic of a PIC representing a rotation without n-delays: Rot-PIC.

FIG. 13 shows a schematic of a simplified circuit where the phase shifters (PSs) in neighboring sections are combined through electronic processing, specifically by adding multiple input data: RZY.

FIG. 14 shows a schematic of a PIC representing a rotation by combining two differential PSs into one: RZY-PS.

FIG. 15 shows a comparison of accuracy vs. number of phase shifters for the hypersphere (6 dimensions) problem.

FIG. 16 shows a comparison of accuracy vs. number of phase shifters for the wavy lines (2 dimensions, 4 classes) problem.

FIG. 17A (Table 1) shows the performance of different methods across various dimensions and configurations.

FIG. 17B (Table 2) shows the performance of Wavy lines and Hypersphere across different percentages.

FIG. 18 shows the comparison of accuracy vs. number of layers for the three-and six-dimensional sphere problem, with and without cyclic shift for the input data.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art that fall within the scope and spirit of the principles of the presently disclosed embodiments.

### DETAILED DESCRIPTION

Various embodiments of the present disclosure are described hereafter with reference to the figures. It would be noted that the figures are not drawn to scale elements of similar structures or functions are represented by like reference numerals throughout the figures. It should be also noted that the figures are only intended to facilitate the description of specific embodiments of the disclosure. They are not intended as an exhaustive description of the disclosure or as a limitation on the scope of the disclosure. In addition, an aspect described in conjunction with a particular embodiment of the disclosure is not necessarily limited to that embodiment and can be practiced in any other embodiments of the disclosure.

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Artificial Intelligence (AI) tasks, such as natural language processing, image processing, speech recognition, and recommendations are conducted by neural networks. These tasks are typically processed electronically, consuming a large amount of energy with relatively slow processing. Neural network transformation refers to the computational process of mapping input data to an output through a series of interconnected nodes (or neurons) organized in layers. Each node performs mathematical operations on the data, such as weighted sums and activation functions, and propagates the results through the network. The transformation is guided by adjustable weight parameters, allowing the neural network to learn complex patterns and make predictions or classifications based on the input data.

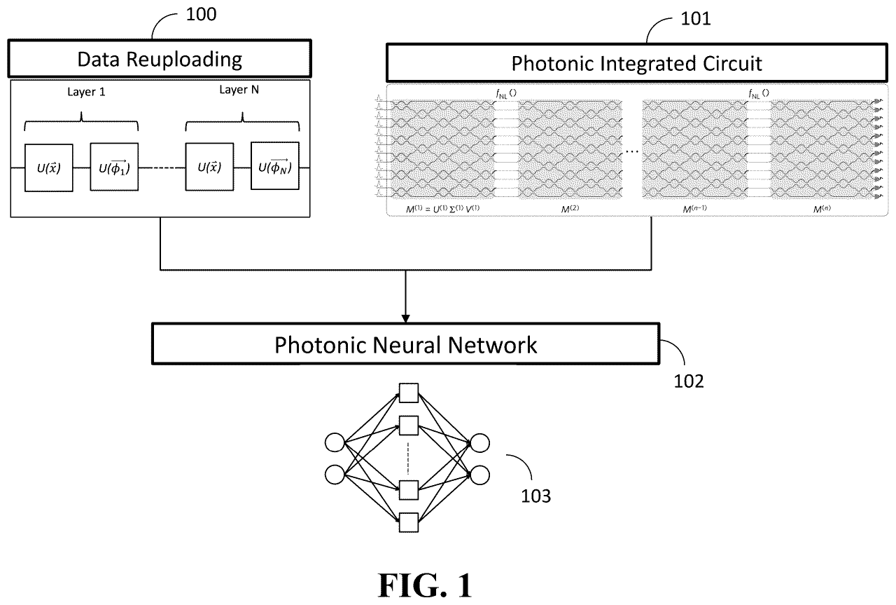

FIG. 1 shows a schematic of a photonic neural network 102 realized through data reuploading 100 in photonic integrated circuits 101, according to some embodiments of the present disclosure. The embodiment shown in FIG. 1 realizes universal non-quantum photonic computing, which can minimize the optical components through a combination of functionalities into a single phase shifter. Furthermore, the embodiment of FIG. 1 may eliminate the use of nonlinear photonic devices, some of which have input-output characteristics that are not flexible enough to easily represent functions. Additionally, nonlinear photonic devices typically use materials that limit large-scale fabrication and integration. Photonic integrated circuits comprised of interferometers and waveguides are limited in their own accord but integrated with data reuploading it is possible to realize a photonic neural that is capable of achieving a task-specific output as would a classic neural network 103.

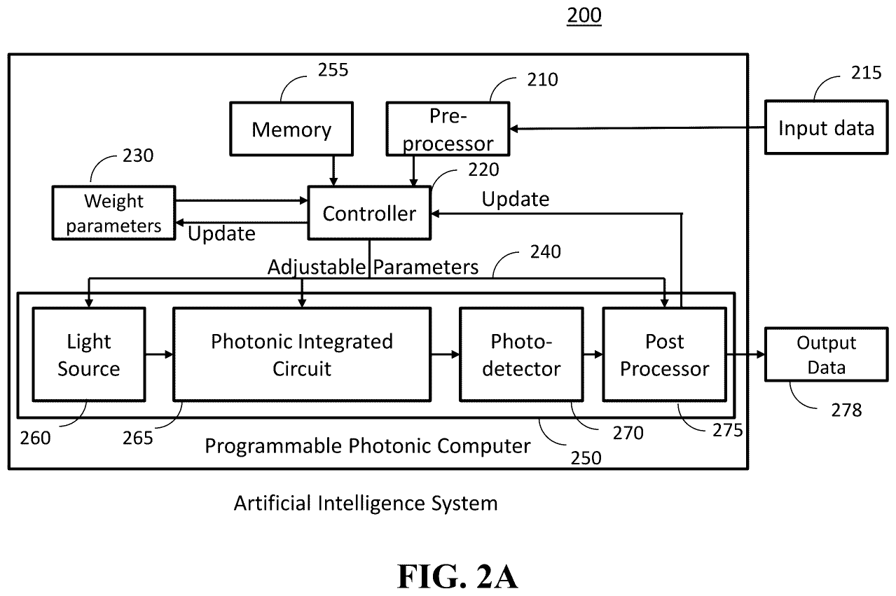

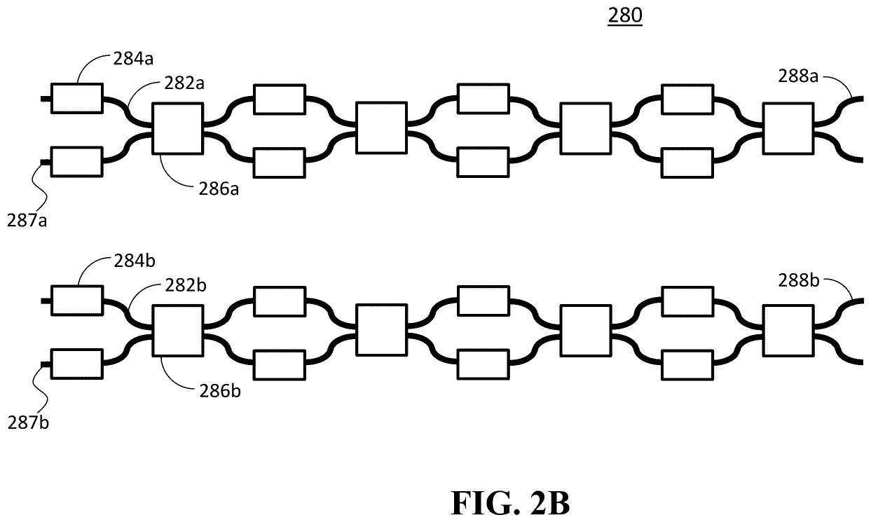

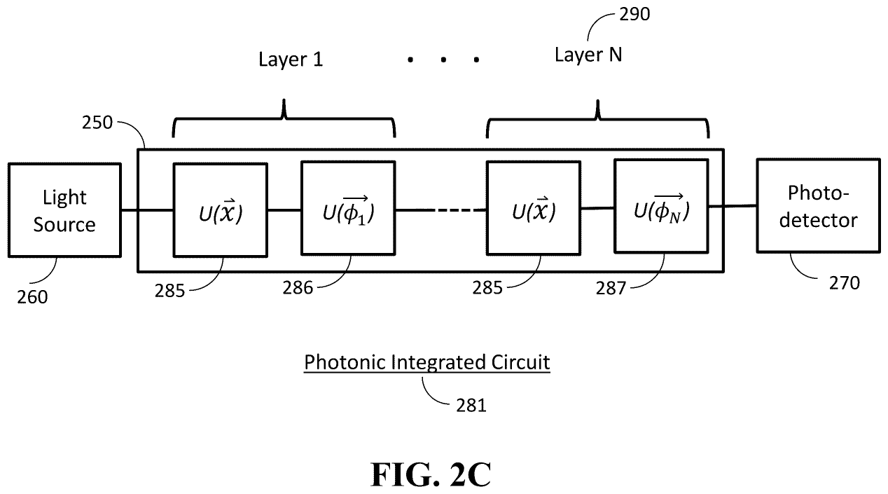

FIG. 2A shows an artificial intelligence (AI) system 200 implemented on a programmable photonic computer 250, according to an embodiment of the present disclosure. Some embodiments realize that the AI system 200 can be realized as a photonic neural network comprised of a series of interferometers and waveguides, thereby avoiding the use of nonlinear photonic devices and thus capable of mimicking classic neural networks. The input data 215 are electronic signals to be processed by the AI system 200. The embodiments of the present disclosure realize that input data can vary from implementation to implementation depending on the design task at hand. In one embodiment input data can be applied as a voltage. The pre-processor 210 receives the input data 215, scaling and ordering it for input into the controller 220. The controller 220 manages the overall computation flow and adjusts a set of parameters 240 to embed both the input data 215 and the weight parameters 230 into the programmable photonic computer 250. The memory 255 stores the computational algorithm. A light source 260 injects light into a set of input ports on the photonic integrated circuit (PIC) 265, while photodetectors 270 capture the lights at the output ports of the PIC 265 and convert them into electronic signals. It is a realization of some embodiments that data reuploading applied to PIC 265 can mimic the operations of a classic neural network. The post-processor 275 amplifies and scales the detected electronic signals from the photodetector 270, to produce the output 278 as an inference prediction according to the design task at hand. The controller receives signals from the post-processor 275, updates the weight parameters 230, and re-adjusts the parameters of the programmable photonic computer 250. In this way, the system performs a neural network transformation of the input data 215, continuously refined by the updated weight parameters 230.

FIG. 2B shows an exampler embodiment of a PIC 280, in which waveguides 282a guide light propagation, phase shifters (PS) 284a adjust the phase of the light, directional couplers 286a or multimode interference (MMI) devices couple and split the light with a 50:50 ratio, as well as input ports 287a and outports 288a. This PIC controls the Pauli rotation of the input states, where Pauli rotation refers to operations that rotate an optical state around the X, Y, or Z axes. Alternatively, another lane of PIC 280 also contains waveguides 282b that guide light propagation, phase shifters (PS) 284b that adjust the phase of the light, directional couplers 286b or multimode interference (MMI) devices to couple and split the light with a 50:50 ratio, as well as input ports 287b and outports 288b. The embodiment in shown FIG. 2B discloses light sources and photodetectors as being external to the PIC. However, in some embodiments, they can be integrated directly onto the same PIC.

Data reuploading shown in FIG. 2C was originally proposed for quantum computing to achieve the universal approximation property (UAP). UAP denotes that a system can approximate any continuous function to any desired accuracy given sufficient resources and training. Unlike classical neural networks, as shown in FIG. 1, the input data x are embedded as Pauli rotation angles repeatedly as U(\tilde{x}) in every layer 290, followed by rotations represented by weight parameters U(\tilde{ϕ}₁) at each layer 290.

FIG. 2C shows an exemplary embodiment of a PIC 281, within a programmable photonic computer 250. A light source 260 injects light into a set of input ports on PIC 281, which utilizes data reuploading to achieve the universal approximation property (UAP). UAP denotes that a system can approximate any continuous function to any desired accuracy given sufficient resources and training. Input data x are embedded as Pauli rotation angles repeatedly as U(\tilde{x}) 285, which are then followed by rotations represented by weight parameters U(\tilde{ϕ}₁) 286. Subsequent layer N, 290, contains input U(\tilde{x}) 285, which is then followed by rotations represented by weight parameters U(\tilde{ϕ}_{N}) 287. The rotations represented by weight parameters U(\tilde{ϕ}_{N}) 287 may be similar or vary to Layer 1 conditions depending on the task at hand. Photodetectors 270 capture the lights at the output ports of the PIC 281 and convert them into electronic signals.

The whole operation f(x) can be described as

$$f ( x ) = {\prod }_{i = 1}^{L} U ( {\vec{ϕ}}_{i} ) U ( \vec{x} )$$

and nonlinearity is imposed without using nonlinear photonic devices due to the repeated embedding. The present disclosure realizes a novel non-quantum approach to photonic data reuploading, which eliminates nonlinear photonic devices, photon counters, and squeezed lights. Various methods to miniaturize optical components and implement multi-label classification using a limited number of photonic ports are explored. Various exemplary embodiments demonstrate through multiple machine learning tasks the potential of the framework as a practical alternative to optical neural network (ONN) methods.

### PIC implementation

As a more detailed description of the unitary operator U, an arbitrary single-qubit operation can be decomposed into Pauli Z/Y/Z rotations:

$$Rot ( ϕ , θ , ω ) = RZ ( ω ) RY ( θ ) RZ ( ϕ ) = [ \begin{matrix}{e}^{- i ( ϕ + ω ) / 2} cos ( θ / 2 ) & - {e}^{i ( ϕ - ω ) / 2} sin ( θ / 2 ) \\ {e}^{- i ( ϕ - ω ) / 2} sin ( θ / 2 ) & {e}^{i ( ϕ + ω ) / 2} cos ( θ / 2 )\end{matrix} ] . \qquad ( 1 )$$

This operation can be realized optically in the following manner.

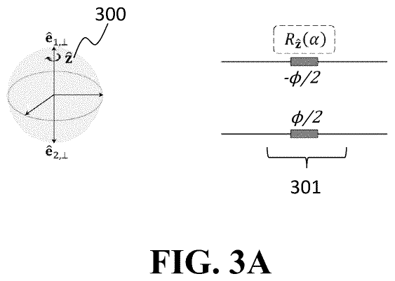

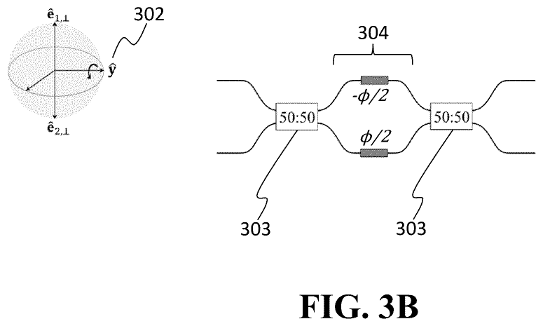

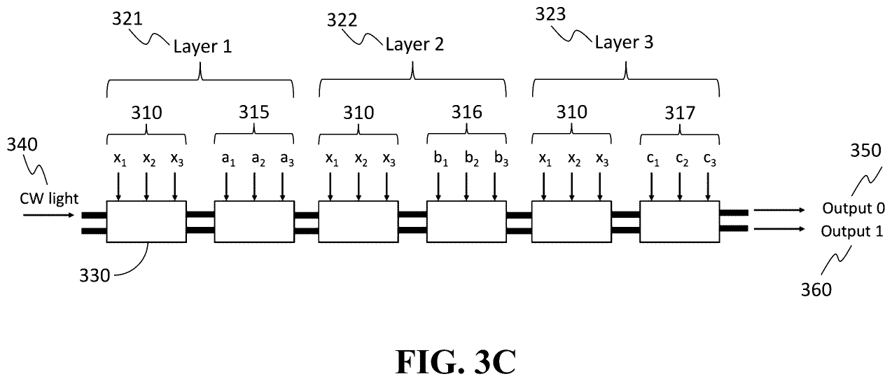

FIG. 3A illustrates a single-qubit rotation along the z-axis 300, implemented through a differential phase shift 301, represented by:

$$RZ ( ω ) = [ \begin{matrix}{e}^{- i ϕ / 2} & 0 \\ 0 & {e}^{i ϕ / 2}\end{matrix} ] . \qquad ( 2 )$$

The phase shifts are achieved by changes in the refractive index, induced either by local heaters or electro-optic materials.

FIG. 3B shows a single qubit rotation along the y-axes 302, wherein a pair of 50:50 directional couplers 303 and a differential phase shifter 304 are used.

$$RY ( θ ) = [ \begin{matrix}cos ( θ / 2 ) & - sin ( θ / 2 ) \\ sin ( θ / 2 ) & cos ( θ / 2 )\end{matrix} ] . \qquad ( 3 )$$

This part may be referred herein as an interferometer. In fact, RX can be expressed by the combination of RY and RZ, so the rotation as shown in Eq. (1) is sufficient to represent the universal case. Eq. (1) can be expressed by three rotations, RZ(ω), RY(θ), and RZ(ϕ).

FIG. 3C shows an exemplary embodiment in which a case of three-dimensional input data x=[x₁, x₂, x₃], 310, and a three-layer network illustrate how the operations are conducted. The network has trainable weight parameters \vec{a}=[a₁, a₂, a₃] 315, \vec{b}=[b₁, b₂, b₃] 316 and \vec{c}=[c1, c2, c3] 317 for the first 321, second 322, and third 323 layers respectively. Similar to single-qubit operations in the quantum case, some embodiments have two modes and continuous wave (CW) light 340 or pulsed light injected into one mode (waveguide) and transformed through the PIC. The PIC is controlled by the adjustable parameters based on the input data x and weight parameters \vec{a}, \vec{b}, and \vec{c}. The adjustable parameters may include phase shifts, typically implemented by changing the refractive index, which can be controlled through heaters or via the electro-optic effect, regulated by applied voltage. Some embodiments realize that the adjustable parameters may be set so that the differential phase shift provides a required phase shift, proportional to each element of the input data and weight parameters, ranging from −π to π. Photonic properties of the PIC elements, such as phase shifters, are adjusted accordingly. The output light for each mode is detected by photodetectors, such as non-cryogenic photodetectors. Depending on the method, the amplitude (energy) only, or amplitude and phase information are utilized. The detection can be performed either by non-coherent photodetectors, or coherent photodetectors, respectively. Non-coherent detectors can detect only the amplitude. Coherent photodetectors may use homodyne detection, or heterodyne detection, and can detect both the amplitude and phase of the output light, increasing the information. The weight parameters are trained such that the measurement of the output lights at two modes provides a task prediction, e.g., as a binary class probability.

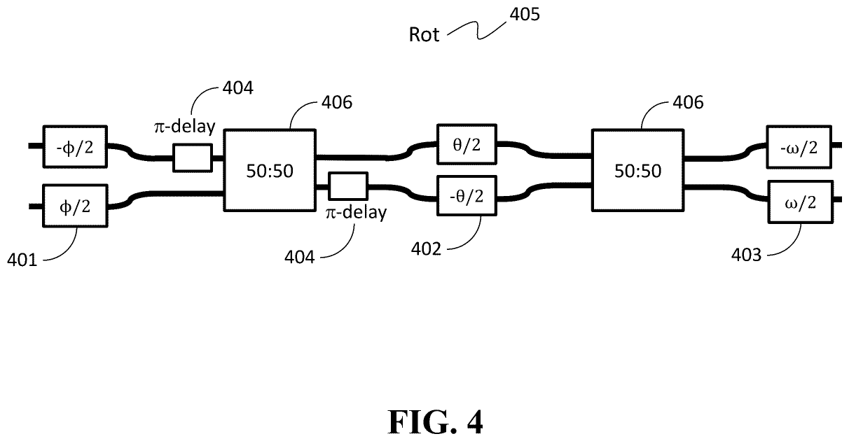

Each of the blocks 330 in FIG. 3C is a rotation block expressed as in Eq. (1), and its PIC realization is shown in FIG. 4, referenced herein as Rot 405. Some embodiments use three pairs of differential phase shifters (PSs) 401, 402, and 403 respectively, to represent the rotation in Pauli Z, Y, and Z axis respectively. Furthermore, the embodiment shown in FIG. 4 also contains two T-delays 404 representing phase shift as well as 50:50 directional couplers 406. Photonic properties of PSs can be adjusted using thermal, current injection, voltage application, mechanical force, or a combination of these methods. Ultimately, CW light 340 is transformed into “output 0” 350 or “output 1” 360, thereby performing a neural network transformation.

The transforming operation of the optical signals may include, but is not limited to, data reuploading, phase shifting, attenuating, wavelength shifting, interferometer coupling, amplifying, oscillating, multiplexing, and modulating.

### Exemplar Embodiment

### Binary Classification

Some embodiments apply the PIC circuit for binary classification problems: three-dimensional sphere and six-dimensional hyper-spheres benchmark. For the measurement at the last layer, some embodiments use logit: log(p₀)−log(p₁) for the measured power p₀ and p₁ at output mode 0 and 1, respectively. For the three-dimensional case, some embodiments use one block of Rot for the input data and another block for the three weight parameters to form a layer. In the case of six-dimensional case, two blocks of Rot can be used to express six input data, and one block of Rot for three weight parameters to form a layer. Some exemplary embodiments use 4096 training data and 1024 test data, wherein the AdamW optimizer of the PyTorch library is used for training with a learning rate of 0.03.

The training process begins with the weight parameters initialized as random numbers. During each iteration, the optimizer computes the gradients of the loss function with respect to the weight parameters. These gradients indicate how much each parameter should be adjusted to reduce the loss, where the loss represents the degree of misclassification. Based on these gradients, the optimizer updates the weight parameters in a direction that aims to maximize accuracy by minimizing the loss.

Referencing the embodiment of FIG. 2A, the computational algorithm can be stored in memory 255 and uploaded to the controller 220. The process begins with the three-or six-dimensional input data 215, which is supplied to the pre-processor 210. The input data is initially scaled to ensure that the entire dataset is normalized within the range of [−1, 1]. The data may then be grouped in the following manners:

For three-dimensional input: (x₁, x₂, x₃)
For six-dimensional input: (x₁, x₂, x₃) and (x₄, x₅, x₆)
These grouped data are supplied to the controller 220.
The weight parameters are initialized and grouped into three-element vectors, such as:

(a₁, a₂, a₃), (b₁, b₂, b₃), . . . (n₁, n₂, n₃), and fed into the controller 220. Controller 220 first configures the light source 260 to emit a constant wave light (1,0) for the two modes (lanes). For the three-dimensional case, the photonic integrated circuit (PIC) 265 is configured with a three-layer design, as shown in FIG. 3C. If the number of layers is N, then 2N blocks are required.

For the six-dimensional case, each layer is comprised of two blocks for the input data, i.e., (x₁, x₂, x₃) and (x₄, x₅, x₆), and one block for the weight parameters, e.g., (a₁, a₂, a₃). The total number of blocks required will be 3N. Controller 220 scales the input data and weight parameters for the photonic integrated circuit 265 to ensure they do not exceed the operating range of the device parameters. The output signals, 0 and 1, are fed into the photodetectors 270. The post-processor 275 amplifies the signals, calculates logit, i.e., log(p₀)−log(p₁), and generates an inference signal, which is fed back to the controller 220. The optimizer running in the controller 220 computes the gradients of the loss function with respect to the weight parameters 230 and the weight parameters are updated. This process is repeated multiple times (e.g., 4096 iterations in this provided embodiment). The training process continues until the inference results converge. During the testing phase, different input data 215 are used to evaluate the output from the post-processor 275. Finally, in the deployment phase, real input data 215 are provided to the system, and the output data 278 is derived from the post-processor 275.

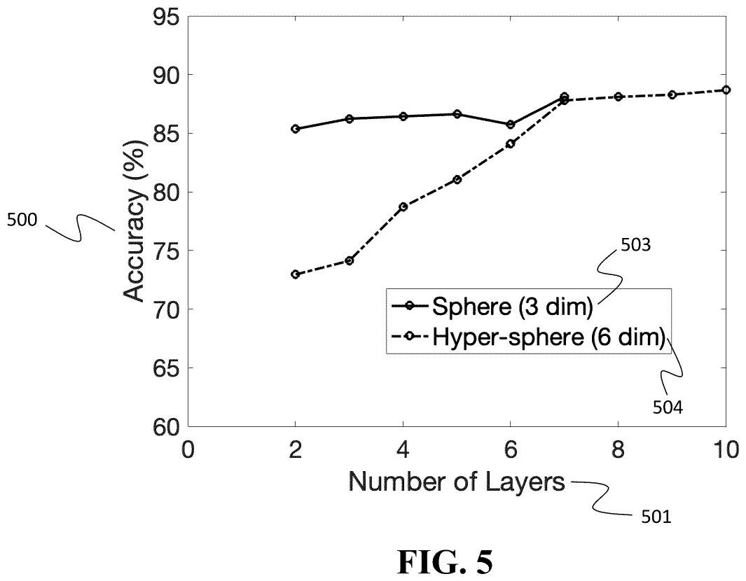

In some embodiments, ten runs with different random number seeds are repeated, and the maximum test accuracy is reported. FIG. 5 shows the classification accuracy 500, i.e., the percentage of accurate classification for the testing data, as a function of the number of layers 501, for the case of sphere (three-dimensional) 503 and hyper-sphere (six-dimensional) 504 cases. These results indicate good showing good performances.

### Exemplar Embodiment

### Non-Binary Classification

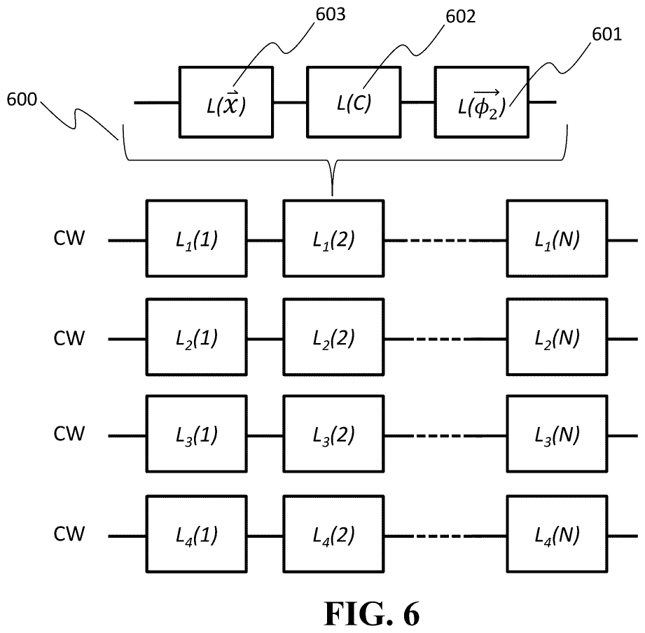

Alternatively, some embodiments consider a non-binary classification task in a two-dimensional wavy lines problem with N=4 classes. With 2-mode optical data reuploading circuits, it is not straightforward to classify multiple classes. There are multiple options including one-vs-one (OvO), one-vs-rest (OvR), and output-coding (OC) strategies to use binary classifiers for multi-label classifications. OvO, OvR, and OC require N(N−1), N, and ceil [log₂(N)] binary classifiers for N-class predictions, respectively. In one embodiment, OvR-based stacking is considered, where N binary-classifying data reuploading circuits are used in parallel to obtain N-class logits as shown in FIG. 6. It requires N-times more weight parameters. To reduce the total number of parameters, a new strategy called implicit classification 600 is introduced, where the trainable parameters are shared across all N binary classifiers but with extra parameters for positional embedding 601 used in each binary classifier. For implicit classification method 600, input data 603 alongside class information is added at each layer as conditional variables C 602 as shown in FIG. 6. In this embodiment, weight parameters can be shared, but the circuit length of the stack is longer with extra class information.

Referencing FIG. 2A, the process begins with the two-dimensional input data 215, which is supplied to the pre-processor 210. The input data is initially scaled to ensure that the entire dataset is normalized within the range of [−1, 1]. The data are then grouped as (x₁, x₂, 0).

In the case of stacking, four sets of circuits are prepared within a PIC. Four sets of the weight parameters are initialized and grouped into three-element vectors and fed into the controller 220. The controller 220 first configures the light source 260 to emit a constant wave light (1,0) for the two modes (lanes) in all four sets of the circuits. The four circuits, with different weight parameters, outputs different signals to photodetectors 270, and the post-processor 275 calculates cross entropy loss using four outputs, giving high value if the output from the correct class, and this value is used for calculating the gradient.

In the case of implicit classification, a single circuit is used, wherein the input data (x₁, x₂, 0), weight parameters, followed by the conditional variables (cond1, cond2, cond3) are used. The conditional variables embed the class information to give different output signals depending on the class condition. Using the same circuit to obtain 4 different outputs over 4 class labels, some embodiments can generate the class logits for cross entropy loss.

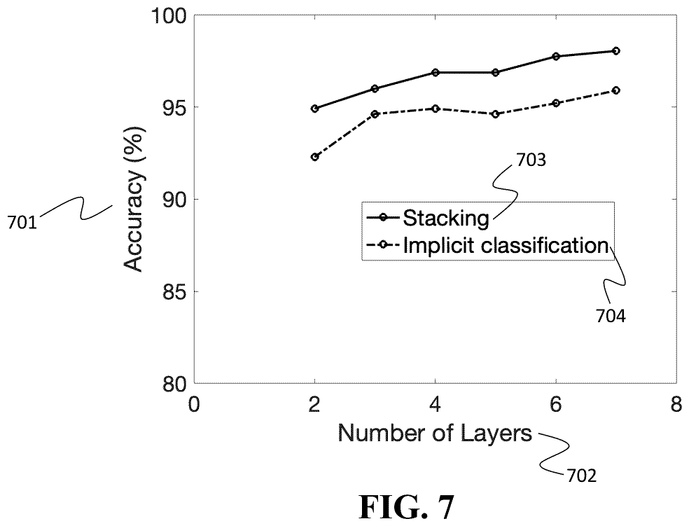

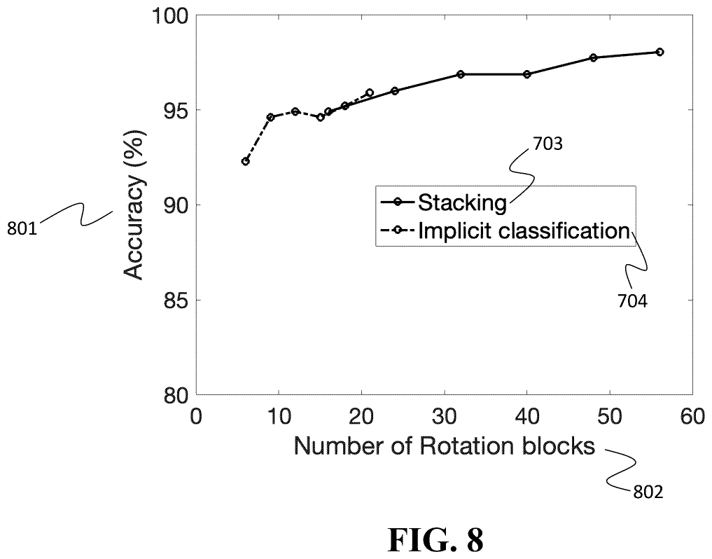

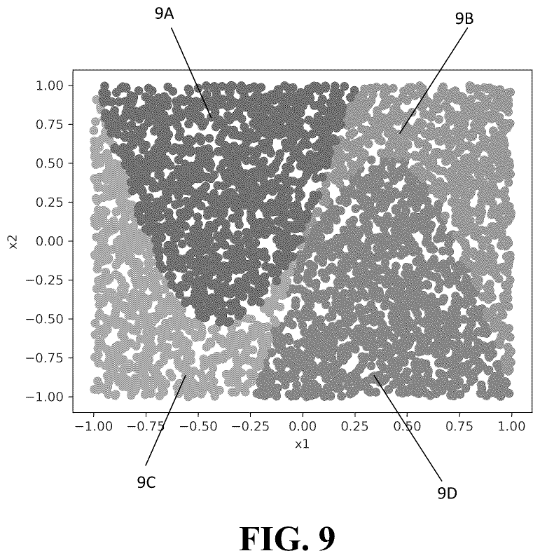

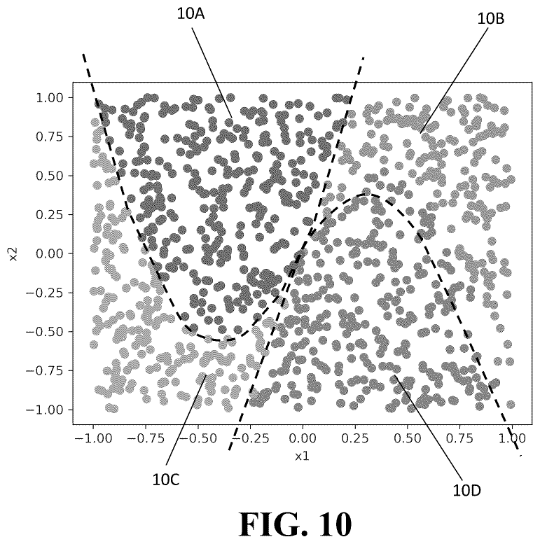

FIG. 7 shows the accuracy 701 of the stacking method 703 and the implicit classification method 704 as a function of the number of layers 702 for the wavy lines problem. FIG. 8 shows the accuracy 801 of stacking method 703 and the implicit classification method 704 as a function of the number of the rotation blocks 802 (Rot). These figures indicate that the stacking method achieves higher accuracy for the same number of layers. However, both methods perform similarly when considering the number of blocks. This is because the implicit classification method uses photonic circuit resources efficiently. FIG. 9 shows the training data of the two-dimensional wavy line problem with four classes of different contrast: 9A, 9B, 9C, and 9D. FIG. 10 shows the best test data with four stacks and seven layers demonstrating 98.05% accuracy.

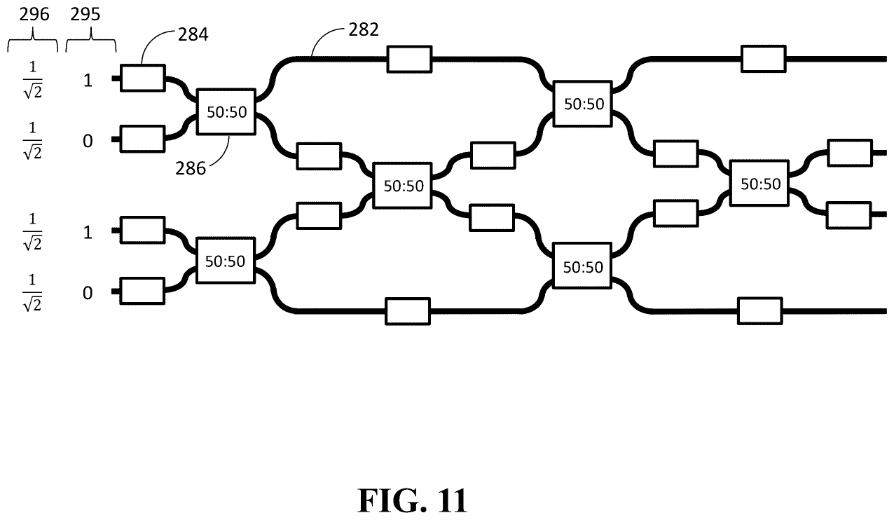

The injected light over multiple ports (modes) can be used for a basis encoding, wherein the injecting light sources can be coherent lasers, partially-or fully incoherent light emitting diodes, multi-wavelength comb lasers, and variants thereof. FIG. 11 shows an exemplary embodiment of a four-mode PIC, wherein phase shifters 284, waveguides 282, and 50:50 directional couplers 286 create a circuit. The basis coding using [1, 0, 1, 0] is shown as 295, while

$$[ \frac{1}{\sqrt{2}} , \frac{1}{\sqrt{2}} , \frac{1}{\sqrt{2}} , \frac{1}{\sqrt{2}} ]$$

is another basis 296, according to an embodiment. These basis encodings can be used as class labels in an embodiment.

Alternatively, multi-wavelength light input can be used as class labels. Since unbalanced interferometers have wavelength-dependent response, different wavelength inputs can be allocated to different classes.

### PIC Variants

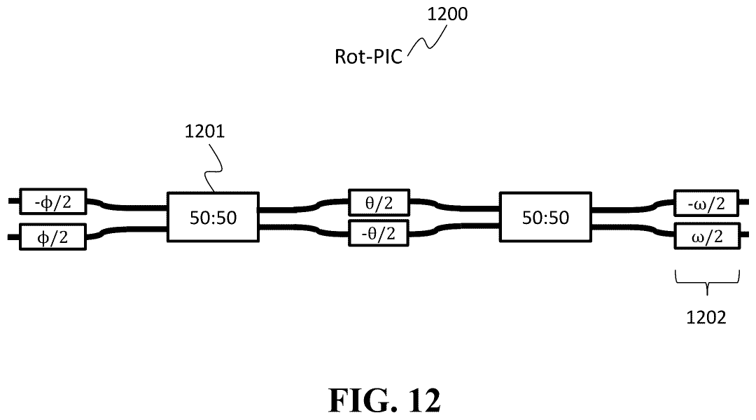

To reduce the number of PSs, some embodiments consider three variants of circuit simplifications below. Initially, two I-delays 404 (reference FIG. 4) are removed from the first 50:50 directional coupler 1201 as shown in FIG. 12, denoted as Rot-PIC 1200. This is equivalent to a 2×2 universal unitary optical processor and also equivalent to Rot (ϕ−π, θ+π, ω). Therefore, this fixed phase difference should be absorbed during the training process.

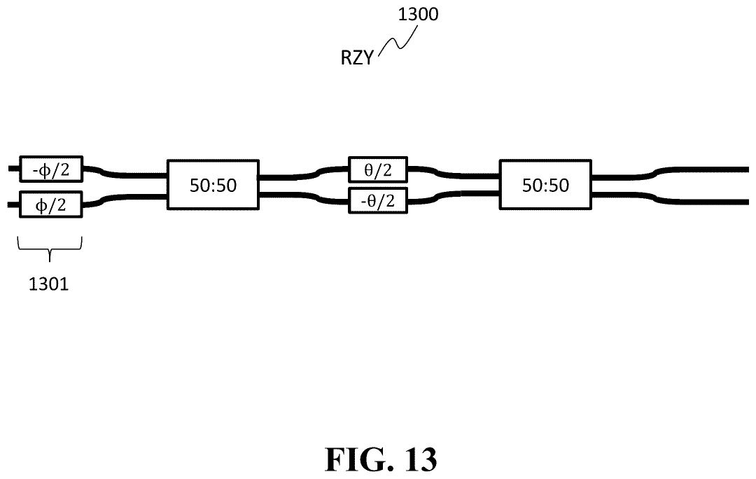

When multiple blocks are cascaded, the last differential PS pair 1202 of each block is directly connected to the first differential PS pair 1301 of the next block as shown in FIG. 13. Therefore, the PS pair can be combined through electronic processing, specifically by adding data of these neighboring sections, referred to herein as RZY 1300.

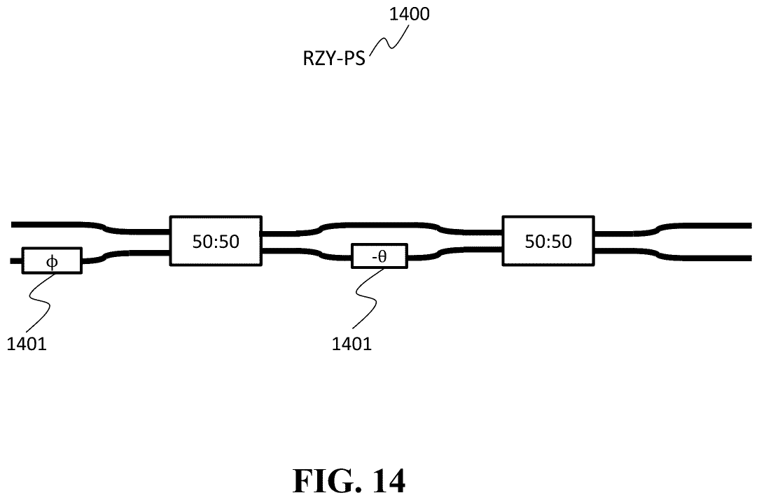

Further, as shown in FIG. 14, the differential PS can be simplified as a single-ended PS 1401 which has twice the amount of phase shift, and is referred to herein as PZY-PS 1400.

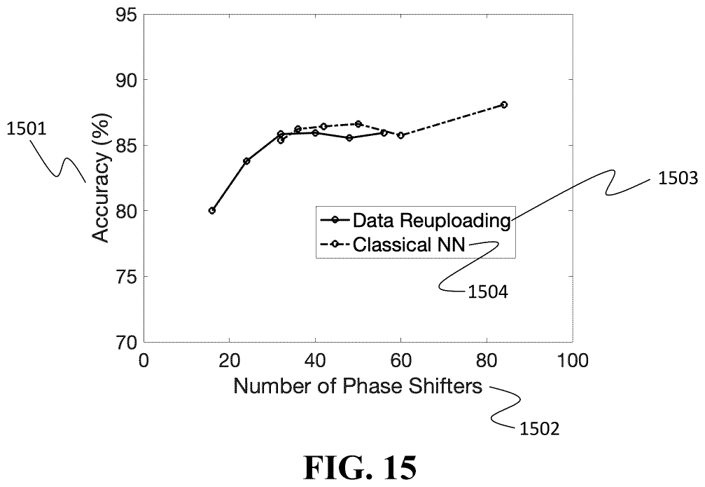

FIG. 15 shows a comparison of simulated accuracy 1501 as function of the number of PSs 1502 for the data reuploading 1503 case using RZY-PS 1400 and a classical three-layer neural network 1504 using a nonlinear hidden layer for the six-dimensional hypersphere problems wherein the classification is made whether the input data has six-dimensional distance from the origin is within a given radius. The figure shows that the data reuploading shows comparable accuracy as the classical neural network using the same phase shifters.

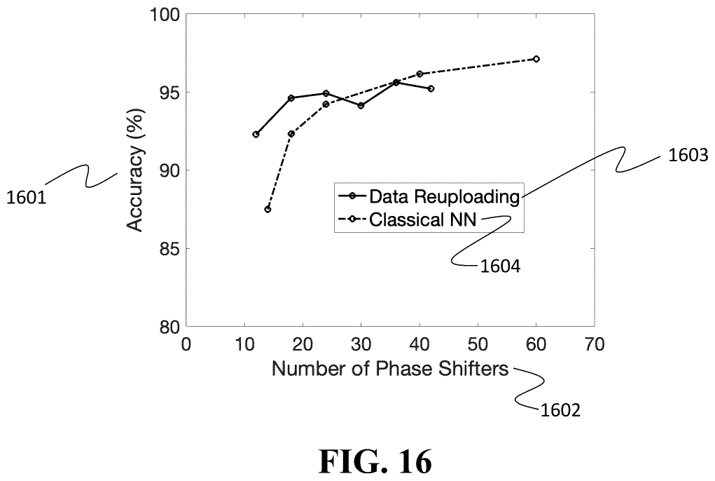

FIG. 16 shows a comparison of simulated accuracy 1601 as function of the number of PSs 1602 for the data reuploading 1603 case using RZY-PS 1400 and a classical three-layer neural network 1604 using a nonlinear hidden layer for the wavy-line problem with two-dimensional output and four classes. The figures shows that the data reuploading shows comparable accuracy as the classical neural network using the same phase shifters.

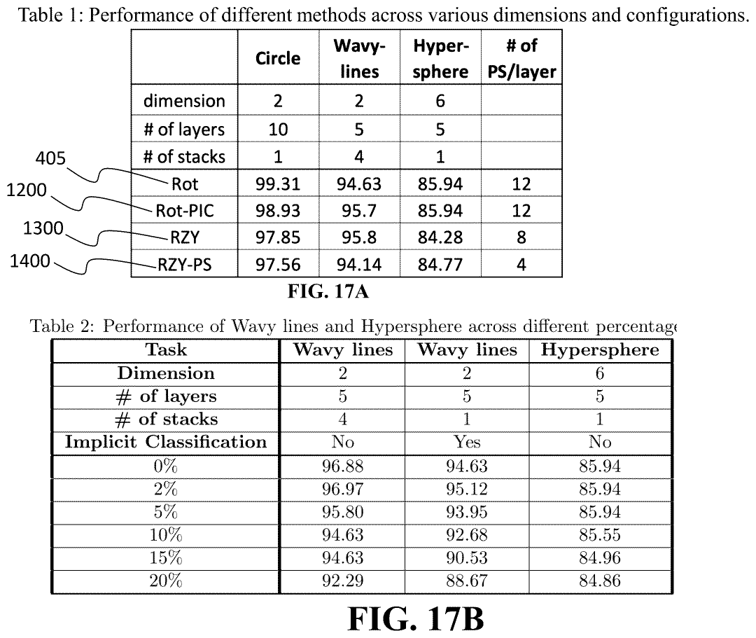

FIG. 17A shows a comparison of the performance for the three problems. The performance among the four different configurations: Rot 405, Pot-PIC 1200, RZY 1300, and RZY-PS 1400 shows comparable results despite the circuit complexity. There may be small performance degradation with RZY-PS 1400. Reducing the number of PSs is typically associated with PSs requiring larger amount of phase shift. Therefore, the choice of circuitry needs to be carefully examined by the overall chip footprint and power consumption.

### Signal Processing

Some embodiments have discussed electronic operations or processing of input data by addition, but the processing can include but is not limited to, subtraction, trigonometric functions, exponential, and logarithmic functions.

The detected lights can be post-processed by being converted into the inference prediction, wherein the post-processing includes but is not limited to electronic operations such as addition, subtraction, multiplication, division, exponential, logarithmic, and trigonometric functions.

Inference prediction refers to the process of utilizing detected data, such as lights, to generate a predictive output or conclusion based on a trained model or algorithm. This process involves analyzing the input data and applying mathematical or statistical models to estimate or predict an outcome, decision, or classification relevant to the application at hand.

The post-processing may be performed by auxiliary neural networks, configured by extra electronic computers, photonic computers, or other computers.

### Tolerance to Fabrication Errors

Multiport interferometers are sensitive to beamsplitter fabrication errors, including Clements configurations. Fabrication error here is defined as the deviation in the splitter from idealistic 50:50. FIG. 17B shows the classification accuracy of the three tasks, two-dimensional wavy lines with four stacks, two-dimensional wavy lines with implicit classification, and six-dimensional hyperspheres, each with five layers, across the increased standard deviation of the splitters. Some embodiments assume that most of the errors are absorbed or trained by the machine learning algorithm using a set of supervised training data such that the inference prediction, which is the output through the programmable photonic processor, is close to the supervised training data under a fabrication of the programmable photonic computer. For the task of wavy lines, the inference prediction gradually degrades when the standard deviation of the splitter is 5% or more, although less so with four stacks than with implicit classification, presumably because the information is spread over multiple stacks. On the other hand, the six-dimensional hypershere task shows small degradation only when the standard deviation is 10% or more. Since the state-of-the-art silicon photonics process can achieve 2% or better, the performance should be acceptable even in the presence of realistic fabrication errors.

### Performance Comparison with Classical Neural Network

Data reuploading demonstrates comparable accuracy without nonlinear photonic devices, to classical neural networks (NNs) when compared with the same number of phase shifters as shown in FIG. 15 for the case of six-dimensional hypersphere problem. For the data reuploading, some embodiments assume the RZY-PS 1400 configuration. Some embodiments realize a more conservative circuit configuration, wherein the number of PSs needs to be adjusted. For classical NNs, one hidden layer and rectified linear unit (ReLU) activation is assumed. For the number of PSs, the embodiment assumes Clements photonic unitary operation configuration. Note that the classical NN does not directly use the Clements configuration for the accuracy calculation, and that this assumes perfect ReLU nonlinear function which is difficult to achieve in a reliable manner for ONN realization. Despite these caveats, it is notable that data reuploading achieves comparable accuracy with classical NNs, without any nonlinear photonic device.

In fact, it is theoretically proven that data reuploading achieves UAP. Hence, the accuracy can be further improved with more layers.

### Phase Shifter Discussion

One potential drawback in implementing photonic data reuploading is the speed of the phase shifter. For many photonic neural networks, phase shifters are implemented using thermal effects to adjust the weight parameters, which is acceptable during the inference stage as fast reconfiguration is not needed. However, data reuploading requires faster phase shifters (PSs) since data needs to be applied at every layer in the PIC. Parity-time symmetry can provide decent acceleration. Alternatively, using ring modulators for phase modulation can be effective. Despite the reported 0.97 dB intensity modulation experimentally demonstrated using silicon ring modulators, this might be acceptable in differential PSs as both arms will experience the same intensity change if biased properly. Other material systems, like InP, GaAs, and thin-film lithium niobate, where electro-optic phase shifters are available, could also be solutions.

### Variant in the Input Data Embedding

In a three-dimensional input example, typically x1, x2, and x3 are input into the blocks multiple times in the same order as (x1, x2, x3). Alternatively, a cyclic shift can be applied to the input data. If the input data are given to the first block as (x1, x2, x3), and (x2, x3, x1) in the second block, and (x3, x1, x2) in the third block, and so on.

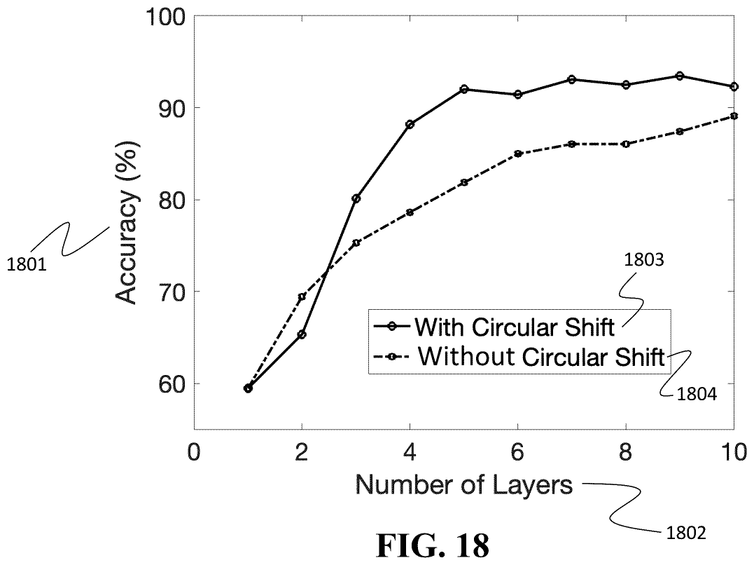

FIG. 18 shows a comparison of two cases: with the cyclic shift 1803, and without any shift 1804. The accuracy 1801 is better with the cyclic shift 1803 as the number of layers 1802 increases.

### Exemplary Embodiments Continued

The following embodiments are described using principles discussed in the previous sections of the specification.

Some embodiments realize an artificial intelligence (AI) system on a programmable photonic computer comprising a pre-processor to process input data and weight parameters. The input data can vary according to the design task at hand, wherein in some embodiments it may be appropriate to select voltage or current. Furthermore, the AI system includes a controller to control a set of adjustable parameters to embed the input data multiple times and weight parameters into the programmable photonic computer as well as a light source to inject lights into a set of input ports of the programmable photonic computer. Additionally, the AI system includes a plurality of sequentially arranged optical layers forming a series of interferometers and waveguides, configured by the set of adjustable parameters to transform the injected lights, a photodetector to detect lights at a set of output ports of the programmable photonic computer, and
a post-processor to output the detected lights as an inference prediction for an AI task as a neural network transformation of the input data adjusted by the weight parameters.

Some embodiments further realize adjusting a set of photonic properties, through the controller, of the programmable photonic computer according to the set of adjustable parameters based on the input data, and weight parameters. The photonic properties may include wavelength multiplexing (WDM), coherence, superposition, interference, diffraction, dispersion, as well as loss and gain. It should also be noted that the adjustable parameters can also vary according to the design task at hand and in some embodiments may include biases, learning rates, activation functions, and number of layers.

Furthermore, some embodiments describe an AI system where at least several of the optical layers comprise a data reuploading unit configured to receive the injected light processed by a previous optical layer and adjust the injected light based on the input data. These same embodiments also include a light modulation unit configured to modulate the injected light adjusted by the data reuploading unit based on control parameters individually determined by the controller for the optical layer.

Additionally, in some embodiments, the AI system includes a plurality of sequentially arranged optical layers including a first optical layer having a first data reuploading optical unit and a first light modulation optical unit, and a second optical layer having a second data reuploading optical unit and a second light modulation optical unit, wherein the controller is configured to control the first data reuploading optical unit and the second data reuploading optical unit using identical control parameters, and wherein the controller is configured to control the first light modulation optical unit and the second light modulation optical unit using different control parameters.

Furthermore, some embodiments of the AI system have the data reuploading optical unit and the light modulation optical unit of each of the optical layers have identical optical structure including light splitters and light combiners arranged to shift the phase of the light based on the control parameters, wherein the optical layers are arranged sequentially to form a propagation path for the light, such that each layer imparts a cumulative, multiplicative phase effect on the light.

Some embodiments realize an AI system, wherein one or a combination of the pre-processor and post-processor is based on an auxiliary neural network configured by an extra electronic computer, photonic computer, or other computers. Auxiliary neural networks when configured by an external system (electronic, photonic, or otherwise), play a supportive or complementary role in enhancing the functionality, performance, or adaptability of a primary neural network.

Alternatively, some embodiments realize an AI system wherein the set of adjustable parameters is trained by a machine learning algorithm based on gradient methods using a set of supervised training data such that the inference prediction is accurate under a fabrication error of the programmable photonic computer. In some embodiments, the controller is configured to independently adjust the parameters in each optical layer, wherein the parameters define at least one of a voltage, temperature, or optical intensity applied to the optical layer.

In some embodiments of the AI system, a class label is included as the conditional variables in the adjustable parameters. In other embodiments, the programmable photonic computer is based on a parallel use of multiple programmable photonic computers. Parallel use of multiple programmable photonic computers can increase performance in the solving of complex problems for a given design task.

Some embodiments of the present disclosure realize an AI method by use of a programmable photonic computer, which embeds input data multiple times and weight parameters into the programmable photonic computer by controlling a set of adjustable parameters, injects lights into a set of input ports of the programmable photonic computer, transforms the injected lights through a series of interferometers and waveguides configured by the set of adjustable parameters,
detects lights at a set of output ports of the programmable photonic computer,
and outputs the detected lights as an inference prediction for an AI task as a neural network transformation of the input data adjusted by the weight parameters. The input data can include electronic operations such as addition, subtraction, multiplication, division, exponential, logarithmic, and trigonometric functions.

Additionally, within some embodiments of the AI method, embedding comprises adjusting a set of photonic properties of the programmable photonic computer according to the set of adjustable parameters based on the input data, weight parameters, and conditional variables. Some embodiments of the AI method include adjusting the set of photonic properties by one or combinations of thermal, current injection, voltage application, and mechanical force.

Some embodiments of the AI method realize that the injecting lights may include controlling light source emission according to a basis encoding, wherein the light source includes coherent lasers, partially-or fully-incoherent light emitting diodes, multi-wavelength comb lasers, lamp, coherent light-emitting diode, multi-wavelength comb laser and variants thereof.

Additionally, some embodiments realize that transforming of the AI method may comprise data reuploading, phase shifting; attenuating; wavelength shifting; interferometer coupling; amplifying; oscillating; multiplexing; and modulating. Other embodiments realize that the detecting of the AI method is based on energy detection, homodyne detection or heterodyne detection using non-coherent photodetectors, coherent photodetectors, or multi-wavelength photodetectors. Furthermore, some embodiments include an AI method in which outputting comprises post-processing to convert the detected lights into the inference prediction, wherein the post-processing includes electronic operations including addition, subtraction, multiplication, division, exponential, logarithmic, and trigonometric functions.

Some embodiments include an AI method wherein the programmable photonic computer is based on an auxiliary neural network configured by an extra electronic computer, photonic computer, or other computers. Other embodiments realize an AI method wherein the set of adjustable parameters are trained by a machine learning algorithm based on gradient methods using a set of supervised training data such that the inference prediction is accurate under a fabrication error of the programmable photonic computer. Furthermore, some embodiments realize an AI method wherein the conditional variables include class labels, are included in the embedded data, wherein the programmable photonic computer is based on a parallel use of multiple programmable photonic computers, wherein the input data are embedded at least two times, or where the input data are embedded in a different order in at least one of layers.

The above-described embodiments of the present disclosure can be implemented using hardware, software, or a combination of hardware and software.

Also, the embodiments of the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

We claim:

1. An artificial intelligence (AI) system on a programmable photonic computer comprising:
a pre-processor to process input data and weight parameters;
a controller to control a set of adjustable parameters to embed the input data multiple times and weight parameters into the programmable photonic computer;
a light source to inject lights into a set of input ports of the programmable photonic computer;
a plurality of sequentially arranged optical layers forming a series of interferometers and waveguides, configured by the set of adjustable parameters to transform the injected lights;
a photodetector to detect lights at a set of output ports of the programmable photonic computer; and
a post-processor to output the detected lights as an inference prediction for an AI task as a neural network transformation of the input data adjusted by the weight parameters.

2. The AI system of claim 1, wherein the controller adjusts a set of photonic properties of the programmable photonic computer according to the set of adjustable parameters based on the input data, and weight parameters.

3. The AI system of claim 1, wherein at least several of the optical layers comprise: a data reuploading unit configured to receive the injected light processed by a previous optical layer and adjust the injected light based on the input data; and a light modulation unit configured to modulate the injected light adjusted by the data reuploading unit based on control parameters individually determined by the controller for the optical layer.

4. The AI system of claim 3, wherein the plurality of sequentially arranged optical layers includes a first optical layer having a first data reuploading optical unit and a first light modulation optical unit, and a second optical layer having a second data reuploading optical unit and a second light modulation optical unit, wherein the controller is configured to control the first data reuploading optical unit and the second data reuploading optical unit using identical control parameters, and wherein the controller is configured to control the first light modulation optical unit and the second light modulation optical unit using different control parameters.

5. The AI system of claim 3, wherein the data reuploading optical unit and the light modulation optical unit of each of the optical layers have identical optical structure including light splitters and light combiners arranged to shift phase of the light based on the control parameters, wherein the optical layers are arranged sequentially to form a propagation path for the light, such that each layer imparts a cumulative, multiplicative phase effect on the light.

6. The AI system of claim 1, wherein one or a combination of the pre-processor and post-processor is based on an auxiliary neural network configured by an extra electronic computer, photonic computer, or other computers.

7. The AI system of claim 1, wherein the set of adjustable parameters is trained by a machine learning algorithm based on gradient methods using a set of supervised training data such that the inference prediction is accurate under a fabrication error of the programmable photonic computer.

8. The AI system of claim 1, wherein the controller is configured to independently adjust the parameters in each optical layer, wherein the parameters define at least one of a voltage, temperature, or optical intensity applied to the optical layer.

9. The AI system of claim 1, wherein a class label is included as the conditional variables in the adjustable parameters.

10. The AI system of claim 1, wherein the programmable photonic computer is based on a parallel use of multiple programmable photonic computers.

11. A artificial intelligence (AI) method by use of a programmable photonic computer comprising:
embedding input data multiple times and weight parameters into the programmable photonic computer by controlling a set of adjustable parameters;
injecting lights into a set of input ports of the programmable photonic computer;
transforming the injected lights through a series of interferometers and waveguides, configured by the set of adjustable parameters;
detecting lights at a set of output ports of the programmable photonic computer;
outputting the detected lights as an inference prediction for an AI task as a neural network transformation of the input data adjusted by the weight parameters.

12. The AI method of claim 11, wherein the input data comprises electronic operations including addition, subtraction, multiplication, division, exponential, logarithmic, and trigonometric functions.

13. The AI method of claim 11, wherein the embedding comprises adjusting a set of photonic properties of the programmable photonic computer according to the set of adjustable parameters based on the input data, weight parameters, and conditional variables.

14. The AI method of claim 13, wherein the set of photonic properties are adjusted by one or combinations of thermal, current injection, voltage application, or mechanical force.

15. The AI method of claim 11, wherein the injecting lights comprises controlling light source emission according to a basis encoding, wherein the light source includes coherent lasers, partially-or fully-incoherent light emitting diodes, multi-wavelength comb lasers, lamp, coherent light-emitting diode, multi-wavelength comb laser and variants thereof.

16. The AI method of claim 11, wherein the transforming comprises data reuploading, phase shifting; attenuating; wavelength shifting; interferometer coupling; amplifying; oscillating; multiplexing; and modulating.

17. The AI method of claim 11, wherein the detecting is based on energy detection, homodyne detection or heterodyne detection using non-coherent photodetectors, coherent photodetectors, or multi-wavelength photodetectors.

18. The AI method of claim 11, wherein the outputting comprises post-processing to convert the detected lights into the inference prediction, wherein the post-processing includes electronic operations including addition, subtraction, multiplication, division, exponential, logarithmic, and trigonometric functions.

19. The AI method of claim 11, wherein the programmable photonic computer is based on an auxiliary neural network configured by an extra electronic computer, photonic computer, or other computers.

20. The AI method of claim 18, wherein the post-processing is based on an auxiliary neural network configured by an extra electronic computer, photonic computer, or other computers.

21. The AI method of claim 11, wherein the set of adjustable parameters are trained by machine learning algorithm based on gradient methods using a set of supervised training data such that the inference prediction is accurate under a fabrication error of the programmable photonic computer.

22. The AI method of claim 23, wherein the conditional variables include class labels, are included in the embedded data.

23. The AI method of claim 11, wherein the programmable photonic computer is based on a parallel use of multiple programmable photonic computers.

24. The AI method of claim 11, wherein the input data are embedded at least two times.

25. The AI method of claim 11, wherein the input data are embedded in a different order in at least one of layers.
